(19) United States
(12) Patent Application Publication
(10) Pub. No.: US 2010/0293247 A1
(43) Pub. Date: Nov. 18, 2010

(54) APPLICATION OF SOCIAL NETWORKING DATA

(75) Inventors: Martin W. MCKEE, Herndon, VA (US); Paul T. SCHULTZ, Colorado Springs, CO (US); Robert A. SARTINI, Colorado Springs, CO (US); Hubert SIEH, Reston, VA (US)

Correspondence Address: VERIZON;PATENT MANAGEMENT GROUP, 1320 North Court House Road, 9th Floor, ARLINGTON, VA, 22201-2909, US

(73) Assignee: Verizon Patent and Licensing Inc., Basking Ridge, NJ (US)

(21) Appl. No.: 12/467,716

(22) Filed: May 18, 2009

(51) Int. Cl. G06F 15/173

(52) U.S. Cl. 709/218

(57) ABSTRACT

A method may include transmitting or receiving a communication in a non-social network, where the communication is between a user and one or more other users, selecting a social network based on the communication, accessing the social network, searching for social network information related to the one or more other users, retrieving the social network information based on the searching, and providing a non-social network service based on the social network information.

### BACKGROUND

Social networks are increasingly becoming a popular platform for individuals or organizations to communicate with one another. Typically, a social network allows individuals or organizations to share interests, ideas, beliefs, and/or views, develop friends or business relationships, sustain communication with existing friends or family, or simply provide an open forum for anyone to communicate.

Given the expansive nature and various forms of communication available today, users of social networks can accumulate a large number of “connections.”

### BRIEF DESCRIPTION OF THE DRAWINGS

FIG. 1 is a diagram illustrating an overview of exemplary embodiments described herein;

FIG. 2 is a diagram illustrating exemplary devices of the network depicted in FIG. 1;

FIG. 3 is a diagram illustrating an exemplary social graph;

FIG. 4 is a diagram of an exemplary user device depicted in FIG. 1;

FIG. 5 is a diagram illustrating exemplary components of the user device;

FIG. 6 is a diagram illustrating exemplary components of a device that may correspond to the exemplary devices of the network depicted in FIG. 1;

FIG. 7 is a diagram illustrating exemplary functional components of the social network communicator depicted in FIG. 2;

FIG. 8 is a flow diagram illustrating an exemplary process for obtaining and utilizing social network information;

FIG. 9 is a flow diagram illustrating another exemplary process for obtaining and utilizing social network information; and

FIGS. 10-13 are diagrams illustrating exemplary graphical user interfaces (GUIs) that include social network information relating to various non-social network services.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

The term “connection,” as used herein, is intended to be broadly interpreted to include a social network contact. The social network contact may correspond to an individual, a group of individuals, or an entity (e.g., a business).

The term “social network,” as used herein, is intended to be broadly interpreted to include an electronically accessible site where individuals or entities may interact. Examples of a social network are LinkedIn and Facebook.

The term “social graph,” as used herein, is intended to be broadly interpreted to correspond to a user's relational links with connections. A relational link between the user and the connection signifies a relationship between the user and the connection. The relational link may be direct or indirect. For example, the user may be directly connected to the connection (e.g., the user's best friend). In other instances, the user may be indirectly connected to the connection (e.g., a friend of a friend). Given this framework, the social graph may include one or multiple relational links. The relational link may indicate a degree of affiliation (e.g., closeness or separateness) with a connection in the social network, as well as path information (e.g., how the user is connected or linked to the connection). In some instances, a relational link may not exist between the user and a connection, in which case, the lack of affiliation may be provided to the user.

The term “social network information,” as used herein, is intended to be broadly interpreted to include any information related to the user's participation in or utilization of the social network. For example, social network information may include social network activity information (e.g., postings, messages), profile information (e.g., name, address, telephone number, e-mail address, etc.), presence information (e.g., on-line, not online), or other types of information (e.g., the user's social graph) associated with the user's participation in or utilization of the social network. Social network information may include information pertaining to the user and/or the user's connections (whether a relational link exists or not).

Embodiments described herein relate to obtaining and utilizing social network information, associated with a social network(s) to which the user belongs, for a communication that occurs outside of the social network and in which the user is a participant. The communication that occurs outside of the social network may include any form of electronic communication. By way of example, the communication may include an e-mail, a telephone call, a video call, a short messaging service (SMS) message, a multimedia messaging service (MMS) message, an instant message (IM), and/or a paging message. The utilization of the social network information for a communication, which occurs outside of the social network, may provide the user with, among other things, an enhanced context with respect to the communication and/or an enhanced context with respect to the other participant(s) associated with the communication.

As will be described herein, the social network information may be utilized in various ways. In one embodiment, the social network information may be provided to the user with respect to a communication between the user and another participant. For example, before (e.g., during call set-up) or during the communication, the social network information, associated with the other participant, may be provided to the user. In another embodiment, the social network information may be utilized to manage communications. For example, an inbound communication may be screened (e.g., directed to voicemail, assigned a particular ringtone or some other type of cue (e.g., visual, tactile), accepted, etc.) based on the user's social graph and the user's preferences. In yet another embodiment, the social network information may be utilized to sort and/or prioritize communications. For example, the user may receive communications in an order that corresponds to the user's social graph and the strength of the respective relational links associated with the other participants. In still another embodiment, the social network information may be utilized to supplement message-based communications. For example, social graph information (e.g., strength of relational link) and/or a hyperlink to the participant's social network profile or social network activity on the social network may be appended to an e-mail header. In another embodiment, the social network information may be utilized for validating claimed affiliations of unknown participants. For example, in a conference call scenario, the user may examine the social network information, associated with an unknown participant, to verify a claimed affiliation of the unknown participant and/or determine if the unknown participant shares any mutual connections with the user. In another embodiment, an inbound communication may be screened based on a shared data-pool of call tags. A call tag may characterize the communication. For example, a call tag may characterize a telephone number as being a nuisance call. Users of the social network may submit calling party information to the shared data-pool after receiving the telephone call, which occurs outside of the social network. A user may be able to block telephone calls tagged in the shared data-pool or have the call tag information displayed when the user receives the telephone call.

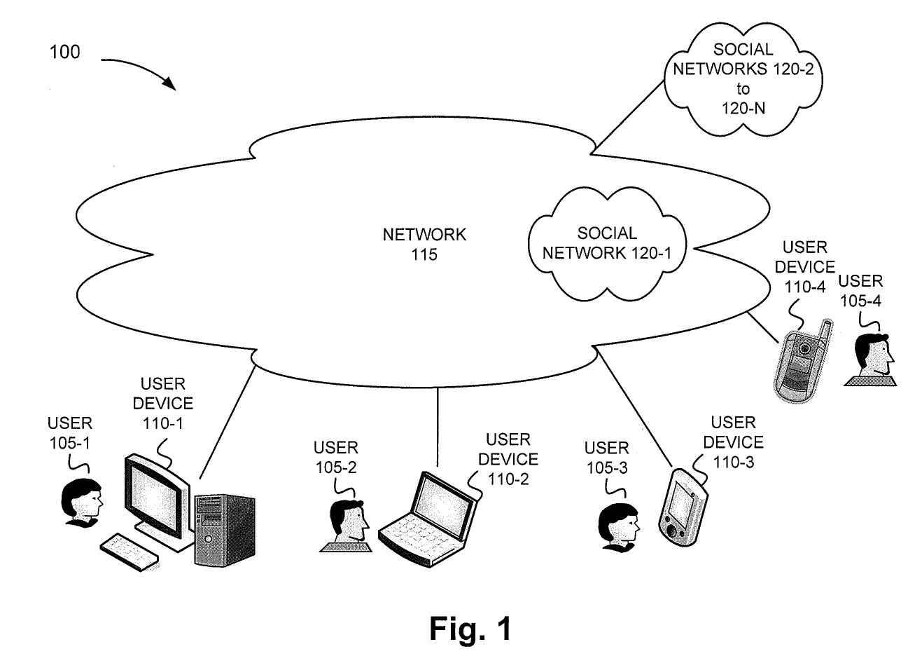

FIG. 1 is a diagram illustrating an overview of exemplary embodiments described herein. As illustrated in FIG. 1, an exemplary environment 100 may include users 105-1 through 105-4 (referred to generally as user(s) 105), user devices 110-1 through 110-4 (referred to generally as user device(s) 110), a network 115 that may include a social network 120-1, and network 115 may be connected to (e.g., communicatively coupled to) social networks 120-2 to 120-N (referred to generally as social network(s) 120).

User device 110 may include a device having communication capability. By way of example, user device 110 may include a wireless telephone (e.g., a mobile phone, a cellular phone), a computational device (e.g., a computer), a personal digital assistant (PDA), a web-browsing device, a personal communication systems (PCS) device, a television (e.g., with a set top box and/or a remote control), a vehicle-based device, and/or some other type of portable, mobile, stationary, or handheld communication device.

Network 115 may include one or multiple networks of any type (i.e., wired and/or wireless). For example, network 115 may include a local area network (LAN), a wide area network (WAN), a telephone network, such as a Public Switched Telephone Network (PSTN), a cellular telephone network, or a Public Land Mobile Network (PLMN), a satellite network, an intranet, the Internet, a data network, and/or a private network. Social network 120 may correspond to a social networking on-line site and/or system that allow individuals to interact.

In an exemplary operation, assume user 105-4 communicates (e.g., places a telephone call) with user 105-3 outside of social networks 120. Based on the communication, a device (not illustrated) in network 115 or a user device (e.g., user device 110-3) may obtain social network information relating to user 105-4. For example, the device or user device 110-3 may search social network 120-2 to which user 105-3 belongs. The device or user device 110-3 may search social network 120-2 based on the calling information (e.g., user's 105-4 telephone number). Additionally, for purposes of discussion, assume that user 105-4 also belongs to social network 120-2. Based on the search, the device or user device 110-3 may obtain social network information relating to user 105-4. The social network information may be utilized in various ways, as previously described.

As a result of the foregoing, by utilizing the social network information with respect to communications occurring outside a social network, non-social networks may provide various services to its users and improve users' interaction with other users in the non-social network.

Since embodiments and implementations have been broadly described, variations to the above embodiments and implementations exist, and will be discussed further below.

It will be appreciated that the collecting of social network information may involve multiple entities. For example, referring to FIG. 1, network 115 may be owned, operated, and/or managed by one entity (e.g., a service provider or a network operator), while social networks 120-2 to 120-N may be owned, operated, and/or managed by other entity(ies) (e.g., a social network provider(s)). By way of example, network 115 may be owned, operated, and/or managed by a service provider, such as Verizon, while social networks 120-2 to 120-N may correspond to social networks, such as, for example, LinkedIn, Facebook, MySpace, etc., which may be owned, operated, and/or managed by social network providers. Alternatively, referring to FIG. 1, network 115 may be owned, operated, and/or managed by a same entity as social network 120-1. By way of example, Verizon may own, operate, and/or manage network 115 and may offer social network services (e.g., social network 120-1) to their subscribers.

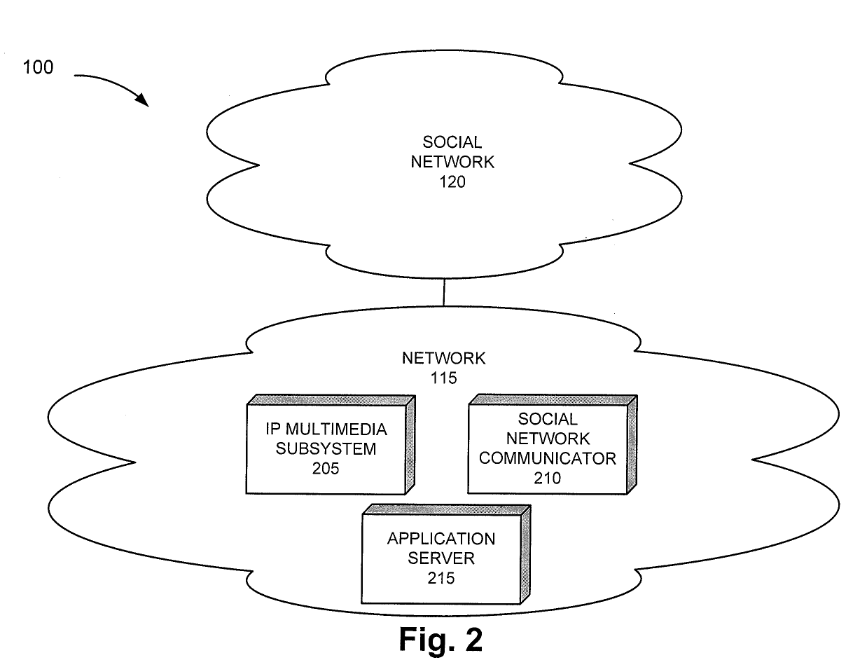

FIG. 2 is a diagram of exemplary devices of the network depicted in FIG. 1. As illustrated in FIG. 2, network 115 may include an Internet Protocol (IP) multimedia subsystem (IMS) 205, a social network communicator (SNC) 210, and an Application Server 215.

IMS 205 may include one or multiple devices that provide access to and/or provisioning of various multimedia and/or voice applications, services, etc. IMS 205 may include, for example, a server, a data center, a computer, and/or some other type(s) of network device(s) that may be utilized to implement an IMS architecture.

SNC 210 may include one or multiple devices that, among other things, collect and/or receive social network information from social network(s) 120. The collected or received social network information may be utilized to provide various services to user 105, as described herein. SNC 210 may include, for example, a server, a data center, a computer, and/or some other type of network device. SNC 210 will be described in greater detail below.

Application Server 215 may include one or multiple devices that, among other things, provide a variety of communication services (e.g., voice, video, data, SMS, MMS, etc.) to users (i.e., person-to-person communication, person-to-group communication, and/or person-to-content communication). IMS 205 and/or Application Server 215 may obtain and/or provide session information associated with communication services.

Although FIG. 2 illustrates exemplary devices, in other implementations, fewer, additional, and/or different devices, or a different arrangement of devices than those illustrated in FIG. 2, and described herein, may be implemented. For example, although IMS 205 with Application Server 215 is an exemplary implementation to provide communication services to its users 105, other types of architectures, standards, network devices, etc., may be implemented to provide communication services to its users 105. Additionally, or alternatively, in other embodiments, IMS 205 and/or Application Server 215 may include SNC 210. Additionally, or alternatively, functions associated with SNC 210 may be implemented, wholly, or partially, in user device 110. Additionally, or alternatively, functions associated with SNC 210 may be implemented in a centralized or a distributed manner.

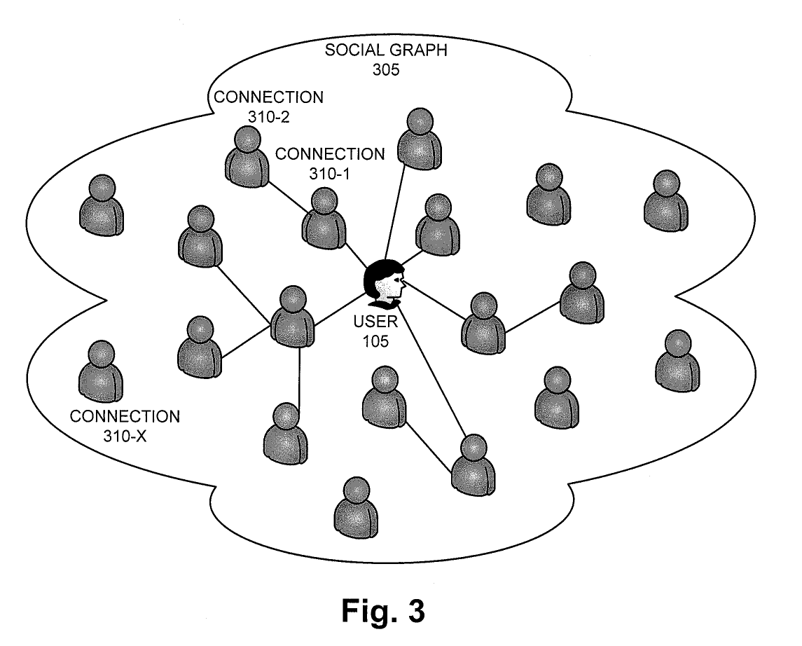

FIG. 3 is a diagram illustrating an exemplary social graph 305. Social graph 305 may be created by social network 120, network 115 (e.g., SNC 210), and/or user device 110 based on social network information. As illustrated, user 105 may have connections 310. For example, as illustrated in FIG. 3, social graph 305 may include connections 310-1, 310-2, and 310-X (referred to generally as connection 310). Connection 310-1 may represent a connection considered a first tier or direct connection (e.g., a close friend). Connection 310-2 may represent a connection considered a second tier or indirect connection (e.g., a friend of a friend). Connection 310-X may be considered a connection that has no link to user 105, yet is a user of social network 120. In other implementations, social graph 305 may include a different arrangement or characterization of connections 310 with respect to user 105.

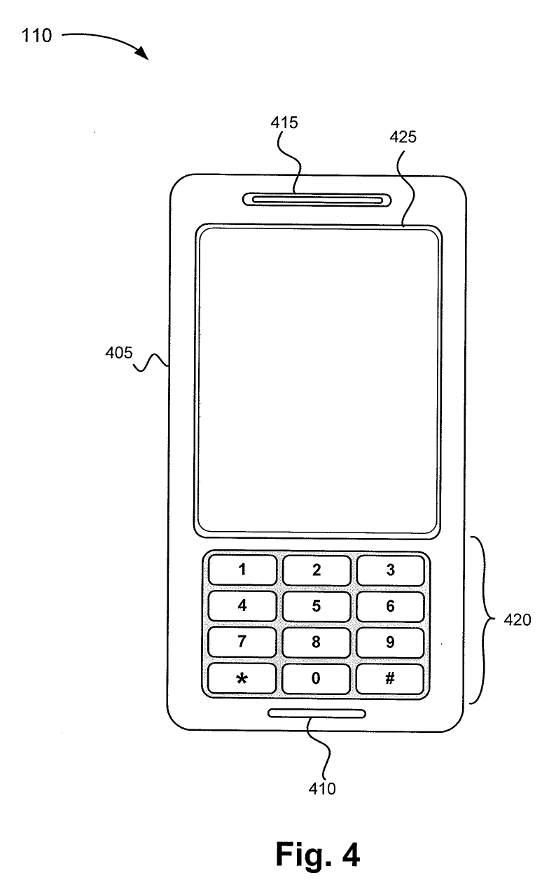

FIG. 4 is a diagram of an exemplary user device 110 in which the embodiments described herein may be implemented. As illustrated in FIG. 4, user device 110 may include a housing 405, a microphone 410, a speaker 415, a keypad 420, and a display 425. In other embodiments, user device 110 may include fewer, additional, and/or different components, or a different arrangement of components than those illustrated in FIG. 4 and described herein.

Housing 405 may include a structure to contain components of user device 110. For example, housing 405 may be formed from plastic, metal, or some other material. Housing 405 may support microphone 410, speaker 415, keypad 420, and display 425.

Microphone 410 may transduce a sound wave to a corresponding electrical signal. For example, a user may speak into microphone 410 during a telephone call or to execute a voice command. Speaker 415 may transduce an electrical signal to a corresponding sound wave. For example, a user may listen to music or listen to a calling party through speaker 415.

Keypad 420 may provide input to user device 110. Keypad 420 may include a standard telephone keypad, a QWERTY keypad, and/or some other type of keypad. Keypad 420 may also include one or more special purpose keys. In one implementation, each key of keypad 420 may be, for example, a pushbutton. A user may utilize keypad 420 for entering information, such as text or activating a special function.

Display 425 may output visual content and may operate as an input component. For example, display 425 may include a liquid crystal display (LCD), a plasma display panel (PDP), a field emission display (FED), a thin film transistor (TFT) display, or some other type of display technology. Display 425 may display, for example, text, images, and/or video information to a user. In one implementation, display 425 may include a touch-sensitive screen. Display 425 may correspond to a single-point input device (e.g., capable of sensing a single touch) or a multipoint input device (e.g., capable of sensing multiple touches that occur at the same time). Display 425 may implement, for example, a variety of sensing technologies, including but not limited to, capacitive sensing, surface acoustic wave sensing, resistive sensing, optical sensing, pressure sensing, infrared sensing, gesture sensing, etc.

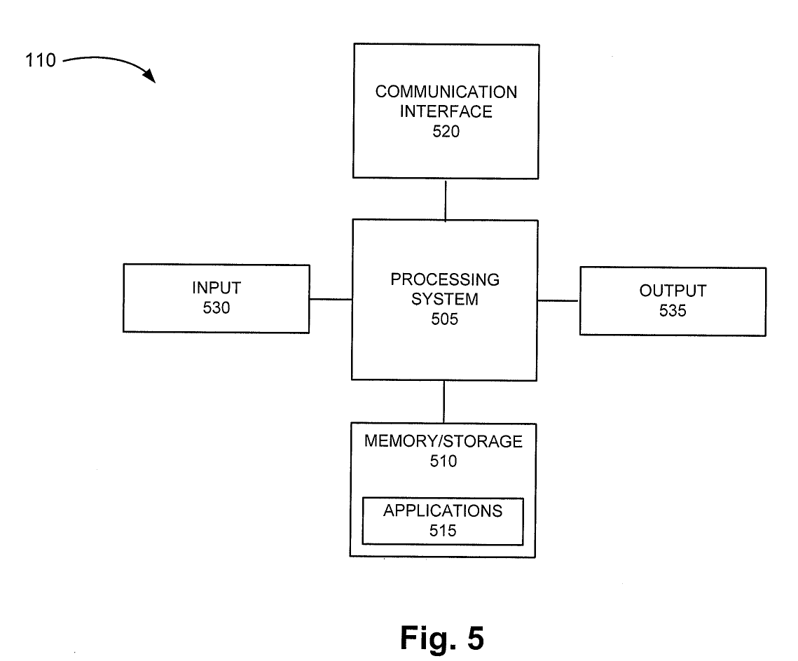

FIG. 5 is a diagram illustrating exemplary components of user device 110. As illustrated, user device 110 may include a processing system 505, a memory/storage 510, a communication interface 520, an input 530, and an output 535. In other embodiments, user device 110 may include fewer, additional, and/or different components, or a different arrangement of components than those illustrated in FIG. 5 and described herein.

Processing system 505 may include one or multiple processors, microprocessors, data processors, co-processors, network processors, application specific integrated circuits (ASICs), controllers, programmable logic devices, chipsets, field programmable gate arrays (FPGAs), and/or some other component that may interpret and/or execute instructions and/or data. Processing system 505 may control the overall operation (or a portion thereof) of user device 110 based on an operating system and/or various applications.

Memory/storage 510 may include memory and/or secondary storage. For example, memory/storage 510 may include a random access memory (RAM), a dynamic random access memory (DRAM), a read only memory (ROM), a programmable read only memory (PROM), a flash memory, and/or some other type of memory. Memory/storage 510 may include a hard disk (e.g., a magnetic disk, an optical disk, a magneto-optic disk, a solid state disk, etc.) or some other type of computer-readable medium, along with a corresponding drive. The term “computer-readable medium,” as used herein, is intended to be broadly interpreted to include a memory, a secondary storage, a compact disc (CD), a digital versatile disc (DVD), or the like. The computer-readable medium may be implemented in a single device, in multiple devices, in a centralized manner, or in a distributed manner.

Memory/storage 510 may store data, application(s), and/or instructions related to the operation of user device 110. For example, memory/storage 510 may include a variety of applications 515, such as, for example, an e-mail application, a telephone application, a camera application, a video application, a multi-media application, a music player application, a visual voicemail application, a contacts application, a data organizer application, a calendar application, an instant messaging application, a texting application, a web browsing application, a location-based application (e.g., a GPS-based application), a blogging application, and/or other types of applications (e.g., a word processing application, a spreadsheet application, etc.). Memory/storage 510 may include application 515 for obtaining the social network information from social network 120. Memory/storage 510 may include application 515 for providing services to user 105 based on the social network information, as will be described in greater detail below.

Communication interface 520 may permit user device 110 to communicate with other devices, networks, and/or systems. For example, communication interface 520 may include an Ethernet interface, a radio interface, a microwave interface, or some other type of wireless and/or wired interface.

Input 530 may permit a user and/or another device to input information into user device 110. For example, input 530 may include a keyboard, keypad 420, display 425, a touchpad, a mouse, a button, a switch, a microphone, an input port, voice recognition logic, and/or some other type of visual, auditory, etc., input component. Output 535 may permit user device 110 to output information to a user and/or another device. For example, output 535 may include display 425, speaker 415, one or more light emitting diodes (LEDs), an output port, a vibrator, and/or some other type of visual, auditory, tactile, haptic, etc., output component.

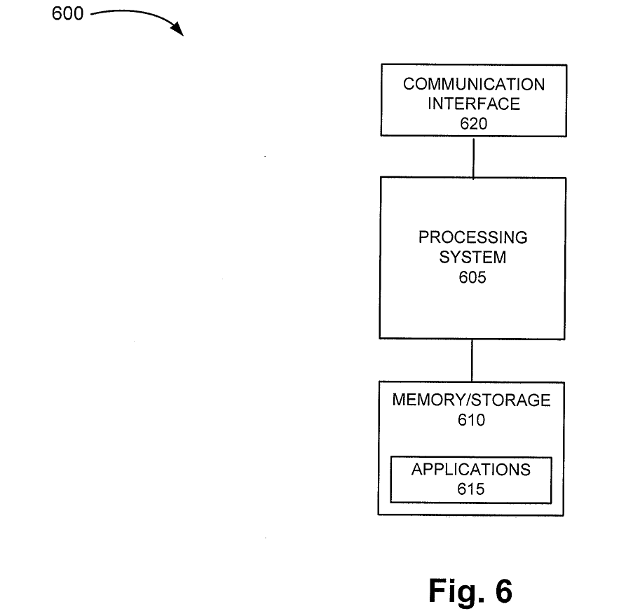

FIG. 6 is a diagram illustrating exemplary components of a device 600 that may correspond to one or more devices in network 115. For example, device 600 may correspond to devices associated with IMS 205, Application Server 215 and/or SNC 210. As illustrated, device 600 may include a processing system 605, a memory/storage 610, and a communication interface 620. In other embodiments, device 600 may include fewer, additional, and/or different components, or a different arrangement of components than those illustrated in FIG. 6 and described herein.

Processing system 605 may include one or multiple processors, microprocessors, data processors, co-processors, network processors, ASICs, controllers, programmable logic devices, chipsets, FPGAs, and/or some other component that may interpret and/or execute instructions and/or data. Processing system 605 may control the overall operation (or a portion thereof) of device 600 based on an operating system and/or various applications.

Memory/storage 610 may include memory and/or secondary storage. For example, memory/storage 610 may include a RAM, a DRAM, a ROM, a PROM, a flash memory, and/or some other type of memory. Memory/storage 610 may include a hard disk (e.g., a magnetic disk, an optical disk, a magneto-optic disk, a solid state disk, etc.) or some other type of computer-readable medium, along with a corresponding drive.

Memory/storage 610 may store data, application(s), and/or instructions related to the operation of device 600. For example, in the instance that device 600 corresponds to Application Server 215, memory/storage 610 may include applications 615, such as, for example, to provide and/or deliver multimedia services to users 105. Applications 615 may also detect, monitor, collect, receive, and/or manage session information associated with a communication occurring outside of social network 120 (e.g., occurring in network 115). Alternatively, in the instance that device 600 corresponds to SNC 210, memory/storage 610 may include applications 615, such as, for example, to obtain session information associated with a communication occurring outside of social network 120 (e.g., occurring in network 115). SNC 210 may also process the social network information and provide various social network services (e.g., providing social network information prior to or during a communication, screening of inbound communications, sorting communications, prioritizing communications, providing call tags, etc.), as described herein. In other embodiments, the obtaining of the social network information, the processing of the social network information and the providing of the various social network services, as described herein, may be implemented in user device 110 or a combination of SNC 210 and user device 110.

Communication interface 620 may permit device 600 to communicate with other devices, networks, and/or systems. For example, communication interface 620 may include an Ethernet interface, a radio interface, a microwave interface, or some other type of wireless interface and/or wired interface.

As previously described, a non-social network that provides communication services may obtain social network information, which may be utilized to enhance the communication services to its users. For example, in one embodiment, a user may receive or place a telephone call from or to another user of the non-social network and receive social network information associated with the calling or called other user. In one implementation, the social network information may be provided to the user prior to the establishment of the communication (e.g., a telephone call). Additionally, or alternatively, the social network information may be provided to the user during the communication (e.g., during the telephone call). In other embodiments, other types of services may be available to the user, such as, for example, managing communications based on the user's social graph, sorting or prioritizing communications based on the user's social graph and/or the affiliations of the other user, providing social network information with communications (e.g., strength of relational link, hyperlinks to social network), providing a shared data-pool of call tags, etc.

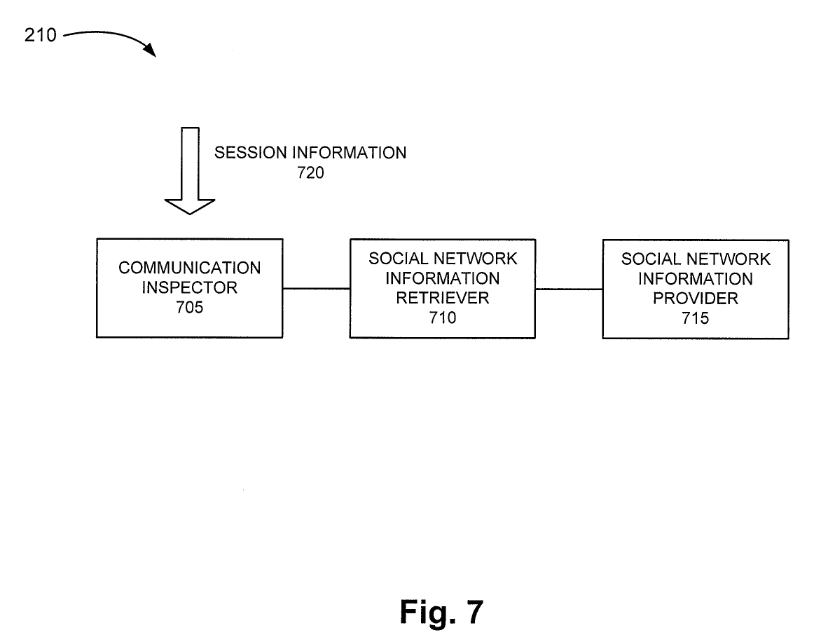

FIG. 7 is a diagram illustrating exemplary functional components of SNC 210. In other embodiments, one or more of the functions associated with SNC 210 may be implemented, wholly, or partially in user device 110. As illustrated, SNC 210 may include a communication inspector (CI) 705, a social network information retriever (SNIR) 710, and a social network information provider (SNIP) 715. CI 705, SNIR 710, and SNIP 715 may be implemented in hardware (processing system 605), a combination of hardware (e.g., processing system 605) and software (e.g., applications 615) or implemented in an analogous manner on user device 110 (i.e., in hardware (e.g., processing system 505) or a combination of hardware (e.g., processing system 505) and software (e.g., applications 515)).

As previously described, one of the services provided to user 105 may include providing social network information. In one implementation, CI 705 may obtain session information 720 associated with a communication occurring outside of social network 120 (e.g., in network 115). Session information 720 may include, for example, a telephone number, a name of user 105, or some other type of information associated with the communication. CI 705 may obtain session information 720, for example, prior to the establishment of the communication (e.g., during a telephone call setup process) or during the communication. In one implementation, CI 705 may obtain session information 720 from Application Server 215. Additionally, or alternatively, CI 705 may obtain session information 720 from one or more other network devices (not illustrated) in network 115 that may obtain and/or have access to session information 720 when the communication occurs. CI 705 may select information from session information 720 which may be utilized to retrieve social network information associated with one or more of the participants in the communication. CI 705 may pass the selected information to SNIR 710.

SNIR 710 may search one or more social networks 120 to which user 105 (a participant that is to receive this service) belongs. In one implementation, SNIR 710 may determine which social networks 120 to search based on information provided by user 105 (e.g., user 105 may provide the service provider associated with network 115 with social network(s) 120 to which user 105 belongs). SNIR 710 may access social network(s) 120 based on credentials (e.g., user name, password, etc.) associated with user 105. SNIR 710 may then search social network(s) 120 based on the selected information provided by CT 705.

SNIR 710 may retrieve social network information based on the search. Depending on the type of social network information, SNIR 710 may, for example, arrange, summarize, filter, and/or re-format the social network information. In other implementations, SNIR 710 may not, for example, arrange, summarize, filter, and/or re-format the social network information. In some instances, SINR 710 may process the social network information based on user's 105 social graph. For example, SNIR 710 may provide information that indicates “degrees of closeness or separateness” of other user 105 to user 105 (e.g., direct connection, an indirect connection, or some other type of nomenclature (e.g., first tier, second tier, third tier, etc.)). Additionally, or alternatively, SNIR 710 may provide information that includes connections of other user 105 (e.g., which may or may not include mutual connections of user 105), and/or path information (e.g., relational link information) of other user 105 to user 105, or other user 105 to connections of user 105.

SNIR 710 may also determine the type of content in the social network information. For example, SNIR 710 may determine whether the social network information includes a profile of other user 105, the social network activity of the other user 105, or both. SNIR 710 may determine the type of content so that the appropriate social network information is provided to user 105 in correspondence to the non-social network service being provided. SNIR 710 may select the appropriate social network information, corresponding to the non-social network service being provided, based on a user-configuration (e.g., user's 105 preference(s), or by the service provider associated with network 115).

SNIR 710 may pass the social network information to SNIP 715. In some instances, SNIP 715 may provide the social network information to user device 110. In one embodiment, user device 110 may utilize the social network information to provide various services. For example, as previously described, communications (e.g., e-mail, SMS, MMS, etc.) may be sorted or prioritized based on the social network information (e.g., user's 105 social graph). In one implementation, a messaging client (e.g., e-mail client, an SMS client, a MMS client, etc.) may sort or prioritize the communications. Additionally, or alternatively, communications may include, for example, social graph information (e.g., strength of relational link) and/or a hyperlink to other user's 105 profile or social network activity on the social network(s) 120.

In other instances, SNIP 715 may provide the social network information to Application Server 215. In one embodiment, Application Server 215 may manage communications based on the social network information. For example, an inbound communication may be screened (e.g., directed to voicemail, assigned a particular ringtone or some other type of cue (e.g., visual, tactile), accepted, etc.) based on user's 105 social graph and user's 105 preferences. In another embodiment, the social network information may include the shared data-pool of call tags. Users 105 that belong to social network(s) 120 may contribute to the shared data-pool of call tags when they (users 105) receive, for example, a telephone call. The shared data-pool of call tags may correspond to, for example, a database. User 105 of social network 120 may either, for example, create or supplement a call tag based on the received telephone call. The call tag (e.g., metadata) may include various types of information that, for example, characterize the calling party and/or describe a purpose associated with the call. For example, a call tag may indicate that the calling party is a salesman, a survey person, or a charity. Additionally, or alternatively, the call tag may indicate the purpose associated with the call, such as, for example, to solicit donations, time-sharing solicitation, or free offers. In other instances, the call tag may include any other type of information (e.g., impressions by users 105, such as, nuisance call, etc.) that users 105 of social network 120 may deem useful to other users 105 (e.g., in terms of deciding to answer the call, having the call blocked, etc.) SNIP 715 may provide Application Server 215 with a call tag that is associated with the session information 720. Application Server 215 may handle the telephone call based on the call tag information. For example, Application Server 215 may block the telephone call or provide the call tag information to user device 110. User 105 may handle the call based on the call tag information. In one implementation, the manner in which Application Server 215 manages the telephone call may be based on user's 105 preferences with respect to the call tags. For example, call tags associated with 1^{st} tier connections may be afforded greater weight than call tags associated with 2^{nd} tier connections.

Although FIG. 7 illustrated exemplary functional components, in other implementations, additional, fewer, or different functional components, and/or a different arrangement of functional components may utilized. Additionally, SNC 210 may, in addition to obtaining social network information from social network(s) 120, obtain information from other resources (e.g., a corporate Intranet, a corporate directory, communications history, the Internet, and/or other resources that may be available to the public or accessible by user 105 (i.e., resources that may accessible by user 105, which may require authorization or some form of user's 105 credentials)). Additionally, it will be appreciated that a function described as being performed by a particular device (or functional component) may, in other implementations, be performed by the particular device (or functional component) in combination with another device (or functional component), or by another device (or functional component). For example, a function described as being performed by Application Server 215 may, in other implementations, be performed by user device 110 and/or SNC 210. Additionally, or alternatively, a function described as being performed by SNC 210 may, in other implementations, be performed by user device 110, Application Server 215 and/or IMS 205.

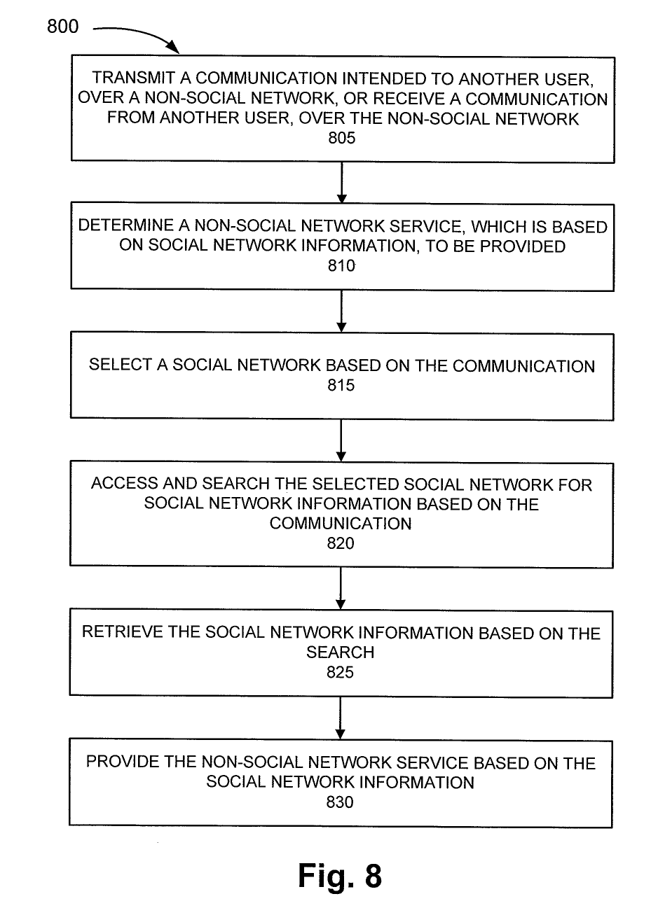

FIG. 8 is a flow diagram illustrating an exemplary process 800 for obtaining and utilizing social network information.

Process 800 may begin with transmitting a communication intended to another user over a non-social network, or receiving a communication from another user over the non-social network (block 805). For example, user 105 may transmit a communication (e.g., a telephone call) to other user 105 via user device 110. Additionally, or alternatively, user 105 may receive a communication from other user 105 via user device 110. The communication transmitted or the communication received may occur via network 115 (i.e., outside of social network 120).

A non-social network service to be provided, which is based on social network information, may be determined (block 810). For example, as previously described, in one embodiment, user 105, via user device 110, may receive social network information regarding other user 105. The social network information may be provided when user 105 is, for example, calling other user 105, or other user 105 is, for example, calling user 105. The social network information provided to user 105 may permit user 105 to, among other things, know more about other user 105, validate other user 105, discern affiliations, closeness to or separateness from other user 105, and social graph paths. In another embodiment, as previously described, inbound communications may be screened based on user's 105 social graph and user's 105 preferences.

In another embodiment, social network information (e.g. call tags) may be provided to user 105 or used to manage inbound communications (e.g., block nuisance calls). The determination as to what non-social network service is invoked, based on the communication, may occur on user device 110, Application Server 215, IMS 205, and/or SNC 210.

A social network may be selected based on the communication (block 815). For example, as previously described, SNIR 710 may select social network(s) 120 to be accessed and searched. In one implementation, SNIR 710 may select social network(s) 120 based on session information 720 associated with the communication. Session information 720 may include information that indicates user 105 as a participant in the communication. For example, as previously described, CI 705 may select information (e.g., user's 105 telephone number) from session information 720 which may be utilized to retrieve the social network information. The information selected from session information 720 may be utilized to determine and/or select social network(s) 120 to which user 105 belongs.

The selected social network may be accessed and searched for social network information (block 820). For example, as previously described, SINR 710 may access the selected social network(s) 120 to which user 105 belongs based on credentials (e.g., user name, password, etc.) associated with user 105. SINR 710 may then search social network(s) 120 based on the selected information provided by CT 705.

The social network information may be retrieved based on the search (block 825). SNIR 710 may retrieve the social network information from social network(s) 120 based on the search.

The non-social network service may be provided based on the social network information (block 830). For example, as previously described, the social network information may be utilized to provide various non-social network services. In one embodiment, the social network information may be provided to user 105, via user device 110, before or during the communication. In another embodiment, when user 105 is receiving the communication, the communication may be screened based on the social network information (e.g., user's 105 social graph). For example, Application Server 215 may obtain the social network information and screen (e.g., send the communication to user's 105 voicemail, assign a particular ringtone or some other type of cue (e.g., visual, tactile) to the communication, accept the communication, etc.) based on the user's 105 social graph and user preferences. In yet another embodiment, when user 105 is receiving the communication, the communication may be screened based on the social network information (e.g., the shared-data-pool of call tags). For example, Application Server 215 may obtain the social network information and block nuisance callers and/or forward call tag information to user device 110.

Although FIG. 8 illustrates exemplary process 800, in other implementations, additional, fewer, and/or different operations than those described, may be performed. Additionally, although a particular operation of process 800 is described as being performed by a device, in other implementations, a different device may perform the operation. Additionally, although process 800 includes obtaining (e.g., searching and retrieving) social network information from social network(s) 120, process 800 may also include obtaining information from other resources (e.g., a corporate Intranet, a corporate directory, the Internet, and/or other resources that may be available to the public or accessible by user 105 (i.e., resources that may accessible by user 105, which may require authorization or some form of user's 105 credentials)).

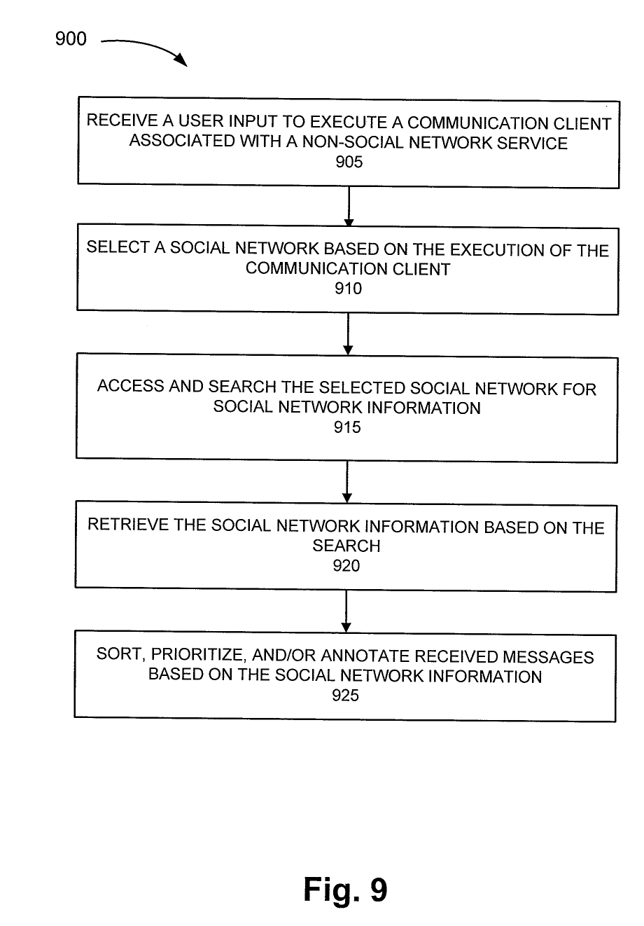

FIG. 9 is a flow diagram illustrating an exemplary process 900 for obtaining and utilizing social network information. As previously described, in one embodiment, social network information may be utilized to sort and/or prioritize communications in an order corresponding to user's 105 social graph. Additionally, or alternatively, communications may include user's 105 social graph information and/or hyperlinks to other user's 105 social network information

Process 900 may begin with a user input to execute a communication client associated with a non-social network service being received (block 905). For example, as previously described, the communication client may include a messaging client (e.g., an e-mail client, an SMS client, a MMS client, etc.). User device 110 may receive a user input from user 105 to execute the communication client.

A social network may be selected based on the execution of the communication client (block 910). For example, the communication client may connect with network 115 (e.g., IMS 205 and/or SNIR 710) to provide received communications to the communication client. Network 115 may select social network 120 based on information associated with the connection (e.g., user's 105 e-mail address, etc.). In other implementations, user device 110 (e.g., the communication client) may select social network 120.

The selected social network may be accessed and searched for social network information (block 915). For example, network 115 or user device 110 may access the selected network 120 to which user 105 belongs based on credentials (e.g., user name, password, etc.) associated with user 105. Network 115 or user device 110 may search social network 120 to locate the social network information. For example, the social network information may include user's 105 social graph and/or social network information associated with other users 105 (e.g., senders of the received communications).

The social network information may be retrieved based on the search (block 920). Network 115 or user device 110 may retrieve the social network information from social network 120 based on the search.

Received messages may be sorted, prioritized, and/or annotated based on the social network information (block 925). For example, as previously described, the social network information may be utilized to sort or prioritize received communications based on the user's 105 social graph. In one implementation, received communications from first tier connections of user 105 may be prioritized over received communications from second tier connections of user 105. Additionally, or alternatively, social network information may be included with the received communication. For example, the received message may include social graph information and/or a hyperlink to other user's 105 profile or social network activity.

Although FIG. 9 illustrates exemplary process 900, in other implementations, additional, fewer, and/or different operations than those described, may be performed. Additionally, although a particular operation of process 900 is described as being performed by a device, in other implementations, a different device may perform the operation.

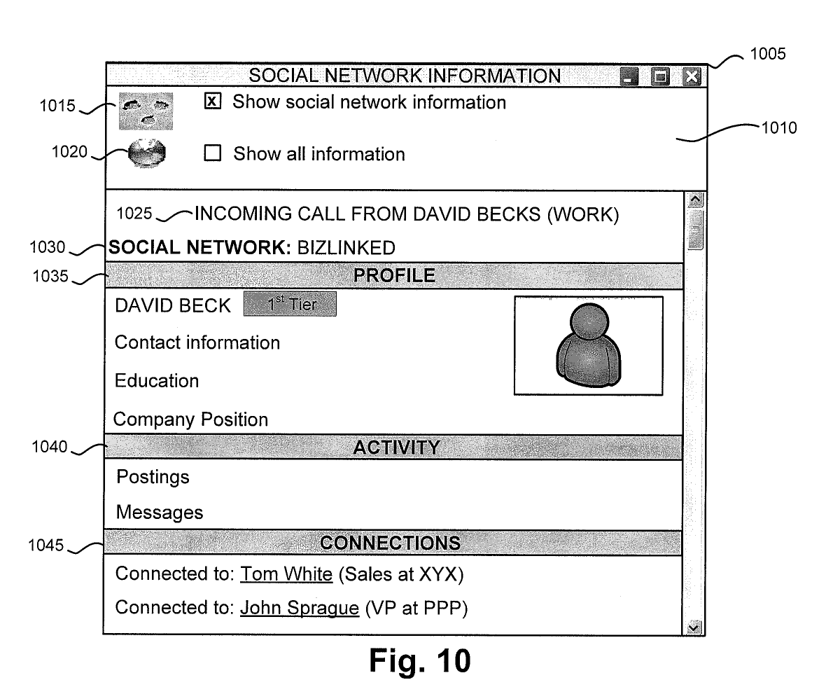

FIGS. 10-13 are diagrams illustrating exemplary GUIs that include social network information relating to various non-social network services. FIG. 10 is a diagram illustrating an exemplary GUI that may correspond to providing social network information during a telephone call. As illustrated in FIG. 10, a GUI 1005 may include a menu 1010. Menu 1010 may include selectors 1015 and 1020. Selector 1015 may permit user 105 to view social network information. Selector 1020 may permit user 105 to view social network information and other information relating to other user 105. The other information may include, for example, information from resources other than social network(s) 120 (e.g., a corporate Intranet, a corporate directory, communications history, the Internet, and/or other resources that may be available to the public or accessible by user 105 (i.e., resources that may accessible by user 105, which may require authorization or some form of user's 105 credentials)).

Indicator 1025 may provide information associated with the communication. For example, indicator 1025 may include the name of other user 105 in which the communication is being transmitted or received, and telephone information (e.g., to/from work, to/from home, etc.). Indicator 1030 may provide information with respect to which social network 120 profile information 1035, network activity information 1040, and connection information 1045, originated. The information contained in profile information 1035, network activity information 1040, and/or connection information 1045 may correspond to other user's 105 profile information, network activity, and connection information. As illustrated, profile information 1035 may include information related to the “closeness or separateness” of other user 105 (e.g., 1^{st} tier connection, direct, indirect, etc.) to user 105. In other implementations, GUI 1005 may include other types of social network information (e.g., affiliations, mutual connections, other types of social graph information (e.g., distance in social graph from user 105)). For example, the distance in social graph from user 105 may be represented as a listing of connections between user 105 and other user 105 in correspondence to user's 105 social graph.

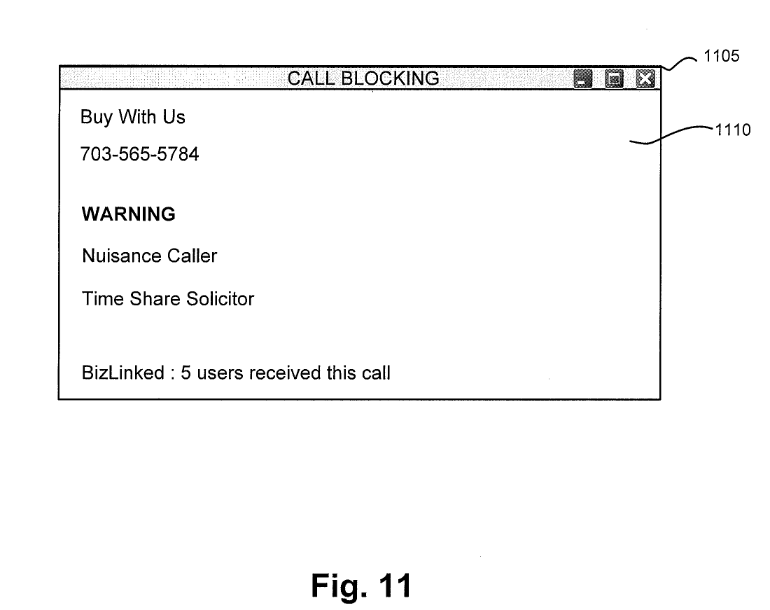

FIG. 11 is a diagram illustrating an exemplary GUI that may correspond to the screening of communications based on the call tags. As illustrated, a GUI 1105 may include a call window 1110. Call window 1110 may include information associated with the telephone call (e.g., caller ID information, such as, “Buy With Us” and “703-565-5784”). Additionally, call window 1110 may include call tag information. For example, call tag information may include a warning to user 105, an identification of the type of call (e.g., nuisance call, time share solicitor), and/or the number of users 105 contributing to the call tag and from which social network 120 the call tag originated (e.g., BizLinked: 5 users received this call).

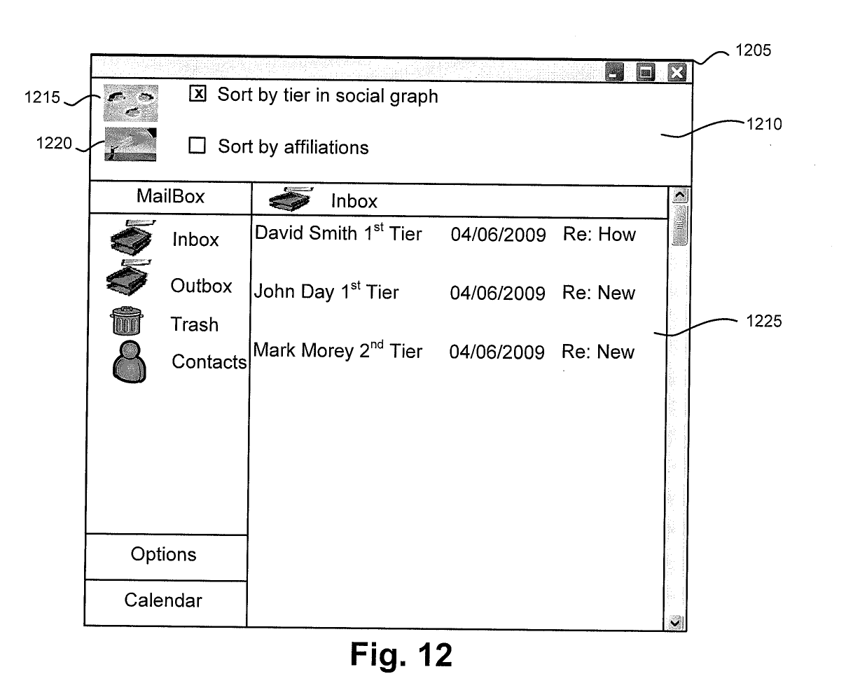

FIG. 12 is a diagram illustrating an exemplary GUI that may correspond to a communication client. As illustrated, a GUI 1205 may include a menu 1210. Menu 1210 may include selectors 1215 and 1220. Selector 1215 may permit user 105 to sort received messages according to tiers in user's 105 social graph. Selector 1220 may permit user 105 to sort received messages according to affiliations (e.g., mutual connections of the sender and user 105). A communication window 1225 may include a listing of received communications in an order corresponding to selector 1215 or selector 1220. For example, as illustrated in FIG. 12, an inbox may present received messages in an order according to tiers associated with user's 105 social graph.

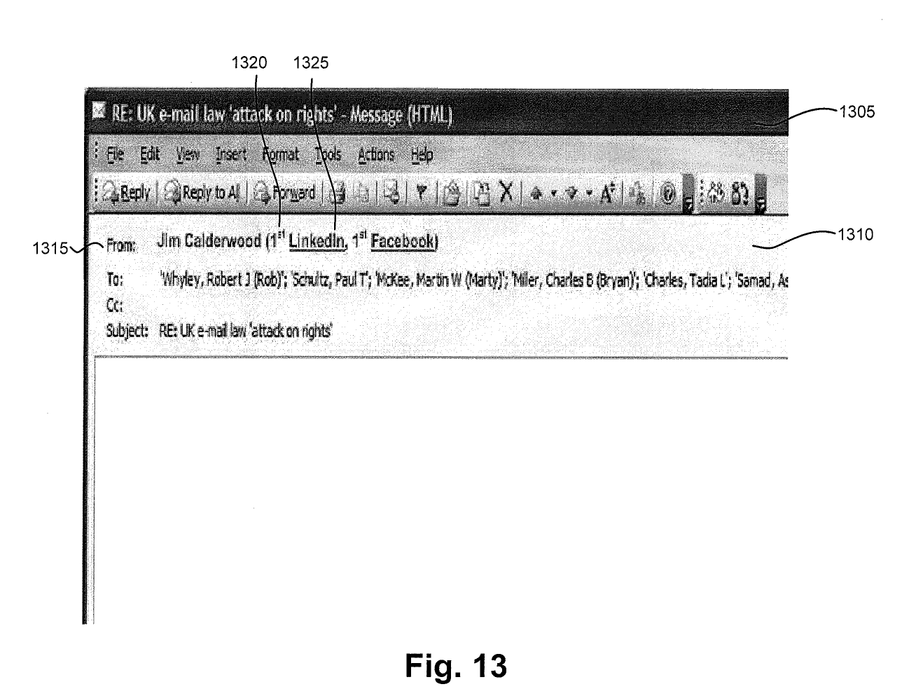

FIG. 13 is a diagram illustrating another exemplary GUI that may correspond to a communication client. For example, a received message 1305 may include header information 1310. Header information 1310 may include a from field 1315. Social network information may be included with received message 1305. For example, as illustrated in FIG. 13, a closeness indicator 1320, and a hyperlink 1325. For example, closeness indicator 1320 may indicate a strength of the relational link associated with the sender of received message 1305. Hyperlink 1325 may provide a link to social network information (e.g., on LinkedIn) associated with the sender of received message 1305.

The foregoing description of implementations provides illustration, but is not intended to be exhaustive or to limit the implementations to the precise form disclosed. Accordingly, modifications to the embodiments, implementations, etc., described herein may be possible.

The term “may” is used throughout this application and is intended to be interpreted, for example, as “having the potential to,” “configured to,” or “being able to,” and not in a mandatory sense (e.g., as “must”). The terms “a,” “an,” and “the” are intended to be interpreted to include one or more items. Where only one item is intended, the term “one” or similar language is used. Further, the phrase “based on” is intended to be interpreted as “based, at least in part, on,” unless explicitly stated otherwise. The term “and/or” is intended to be interpreted to include any and all combinations of one or more of the associated list items.

In addition, while series of blocks have been described with regard to the processes illustrated in FIGS. 8 and 9, the order of the blocks may be modified in other implementations. Further, non-dependent blocks may be performed in parallel.

It will be apparent that the device(s) described herein may be implemented in many different forms of software or firmware in combination with hardware in the implementations illustrated in the figures. The actual software code (executable by hardware) or specialized control hardware used to implement these concepts does not limit the disclosure of the invention. Thus, the operation and behavior of a device(s) was described without reference to the specific software code—it being understood that software and control hardware can be designed to implement the concepts based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, act, or instruction used in the present application should be construed as critical or essential to the implementations described herein unless explicitly described as such.

What is claimed is:

1. A method comprising:
transmitting or receiving a communication, by a user device, in a non-social network, where the communication is between a user and one or more other users;
selecting, by the user device or by a device in the non-social network, a social network based on the communication;
accessing, by the user device or by the device in the non-social network, the social network;
searching, by the user device or by the device in the non-social network, for social network information related to the one or more other users;
retrieving, by the user device or by the device in the non-social network, the social network information based on the searching; and
providing, by the user device or the device in the non-social network, a non-social network service based on the social network information.

2. The method of claim 1, where the communication includes a telephone call or a video call.

3. The method of claim 1, the selecting comprising:
selecting, by the user device or by the device in the non-social network, the social network based on session information associated with the communication.

4. The method of claim 1, further comprising:
determining, by the user device or by the device in the non-social network, the non-social network service to be provided to the user, where the non-social network service includes at least one of providing the social network information to a user of the user device or screening the communication based on the social network information.

5. The method of claim 1, the providing comprising:
displaying, by the user device, the social network information in connection with the communication.

6. The method of claim 1, the providing comprising:
screening, by the device in the non-social network, the receiving of the communication based on the social network information.

7. The method of claim 6, where the social network information includes a social graph associated with the user, the social graph includes one or more relational links that correspond to one or more measures of importance of the one or more other users to the user, and the screening comprising:
determining, when the communication is received, whether the communication should be accepted by the user device or sent to a voicemail system based on the user's social graph.

8. The method of claim 6, where the social network information includes a shared data-pool of call tags, where the call tags characterize the communication based on feedback from users of the social network, and the screening comprising:
determining, when the communication is received, whether the communication should be blocked based on one of the call tags that corresponds to the communication or forwarded.

9. A method comprising:
receiving, by a user device, a user input to execute a communication client capable of receiving communications associated with a non-social network service;
selecting, by the user device or by a device of a non-social network, a social network based on the execution of the communication client;
accessing, by the user device or by the device of the non-social network, the social network;
searching, by the user device or by the device of the non-social network, the social network for social network information;
retrieving, by the user device or by the device of the non-social network, the social network information; and
performing, by the user device, at least one of:
sorting communications received by the communication client in an order based on the social network information; or
adding the social network information to communications received by the communication client.

10. The method of claim 9, the accessing comprising:
accessing, by the user device or by the device of the non-social network, the social network based on credentials associated with a user of the communication client.

11. The method of claim 10, where the social network information includes a social graph associated with the user, and the sorting comprising:
sorting the communications received by the communication client in an order corresponding to the user's social graph.

12. The method of claim 9, where the social network information includes a hyperlink to the social network that contains social network information associated with a sender of the received communication, and the adding comprising:
appending the hyperlink to the communications received by the communication client.

13. A device comprising:
a memory to store instructions; and
a processor to execute the instructions in the memory to:
receive or transmit a communication from or to one or more other users associated with a non-social network;
select a social network to which a user of the device belongs;
retrieve social network information associated with the one or more other users based on session information associated with the communication;
provide a non-social network service to the user based on the social network information.

14. The device of claim 13, where the communication includes a telephone call or a video call, and the non-social network service includes displaying the social network information to the user during a call set-up of the telephone call or during the telephone call.

15. The device of claim 13, where the social network information includes at least one of a social network profile, a social network activity, or a social network connection, associated with the one or more other users.

16. The device of claim 13, where the communication includes a telephone call or a video call, and the non-social network service includes screening the communication, when the communication is received by the device, based on the social network information, and the device is configured to:
provide a cue to the user, in correspondence to the social network information, that permits the user to identify one of the one or more other users.

17. The device of claim 13, where the device includes a telephone having a display.

18. The device of claim 13, where the processor executes the instructions in the memory to:
access the social network based on credentials of the user; and
search the social network for the social network information associated with the one or more other users based on a type of the non-social network service being provided to the user.

19. The device of claim 18, where the processor executes the instructions in the memory to:
search resources, other than the social network, to retrieve information related to the one or more other users.

20. A device comprising:
a memory to store instructions; and
a processor to execute the instructions in the memory to:
receive a user input to execute a communication client for receiving a communication associated with a non-social network, the communication originating from an originating party;
select a social network to which a user of the device belongs;
retrieve social network information from the social network, where the social network information relates to the user and the originating party; and
perform at least one of:
sort communications received by the communication client in an order based on the social network information that pertains to the originating party of the communication, or
add the social network information to communications received by the communication client.

21. The device of claim 20, where the social network information includes a social graph associated with the user, the social graph includes one or more relational links that correspond to one or more measures of importance of the originating party to the user, and the processor to execute the instructions in the memory to:
sort the communications received by the communication client in an order corresponding to the user's social graph.

22. The device of claim 20, where the social network information includes at least one of:
a hyperlink to the social network that, when executed, provides at least one of a social network profile, a social network activity, or a social graph pertaining to the originating party of the communication, or
an indication of a measure of importance of the originating party to the user, where the indication is based on a social graph associated with the user, and the processor to execute the instructions in the memory to:
append at least one of the hyperlink or the indication to the communications received by the communication client.

23. A computer-readable medium containing instructions executable by at least one processor, the computer-readable medium storing instructions for:
transmitting or receiving a communication associated with a non-social network service, between a user and another user;
selecting a social network based on the communication received or transmitted;
accessing the social network;
searching the social network for social network information related to the other user;
retrieving the social network information; and
displaying the social network information during a setting up of the communication or during the communication.

24. The computer-readable medium of claim 23, where the communication includes a telephone call.

25. The computer-readable medium of claim 23, the computer-readable medium storing one or more instructions for:
providing a cue to the user, in correspondence to the social network information, which permits the user to identify the other user, when the communication is received.
